(19) United States
(12) Patent Application Publication
(10) Pub. No.: US 2013/0226600 A1
(43) Pub. Date: Aug. 29, 2013

(54) Method and Apparatus for the Return of Prescription Drugs

(71) Applicant: Matilyn R. Barfield, Carrollton, TX (US)

(72) Inventor: Matilyn R. Barfield, Carrollton, TX (US)

(21) Appl. No.: 13/406,307

(22) Filed: Feb. 27, 2012

(51) Int. Cl. G06Q 50/22

(52) U.S. Cl. 705/2

(57) ABSTRACT

An apparatus for the return of prescription drugs may include a user communication device to input prescription drug data to be returned, a host communication device to receive the prescription drug data and a server to transmit the drug data to the host communication device.

### FIELD OF THE INVENTION

The present invention relates to pharmaceuticals and more particularly to the safe and efficient collection of pharmaceuticals.

### BACKGROUND

Building and promoting practices that create a healthier America is a national priority. Over the last three decades, new medicines and medical technologies have revolutionized health care and helped millions of patients live longer, but in the same period, insufficient methods of handling prescription returns and medical waste by consumers, pharmaceuticals and hospitals are leaving an undesirable mark on our environment and, in turn, on the health of Americans. While America is on the brink of a new era of biopharmaceuticals and personalized medicine, it is desirable to establish value-chains for prescription returns and medicine recycling, to continue to stand by the promise of healthier America. The regulatory environment needed to transform this promise into reality has its foundation in a few key principles which may include: innovation, collaboration, transparency and accountability.

The EPA is proposing to add hazardous pharmaceutical wastes to the Universal Waste Rule. Managing hazardous pharmaceutical wastes as universal wastes provides a streamlined system that is fully protective of public health and the environment. This proposed addition of hazardous pharmaceutical wastes to the Universal Waste Rule, will make it easier for the pharmaceutical industry to collect and properly dispose of hazardous pharmaceutical wastes as hazardous wastes, resulting in a simpler and more streamlined waste management system. It will also encourage generators of pharmaceutical waste to work with FDA approved vendors to dispose of non-hazardous pharmaceutical waste as universal waste, thereby removing unregulated waste from municipal solid waste management systems.

The addition of hazardous pharmaceutical waste to the universal waste rule results in the desirability to facilitate the collection of personal medications from the public. As this proposed rule applies to pharmacies, hospitals, physicians' offices, dentists' offices, outpatient care centers, ambulatory health care services, residential care facilities, and veterinary clinics, as well as other facilities that generate hazardous pharmaceutical wastes, there is a need to approve vendors who can facilitate the recycling of prescription medicine, consumer prescription medicine returns and plastic recycling.

The National Conference of State Legislatures (NCSL) has identified and tracked state legislation to create prescription drug “recycling,” “repository” or “redistribution” programs for unused medication. While details of the laws vary, most allow the return of prescription drugs in single use or sealed packaging from state programs, nursing homes and other medical facilities. The medicines may be redistributed for use by needy residents who cannot afford to purchase their prescribed drugs. This too requires vendors who will facilitate recycling of prescription medicine, consumer prescription medicine returns and plastic recycling.

Within the 2012 reauthorization bill of the Prescription Drug User Fee Act (PDUFA), the FDA will also look into methods that are efficient, predictable and well-coordinated, helping to ensure that Americans have timely access to safe and effective medicine.

### SUMMARY

An apparatus for the return of prescription drugs may include a user communication device to input prescription drug data to be returned, a host communication device to receive the prescription drug data and a server to transmit the drug data to the host communication device.

An apparatus for the return of prescription drugs may include a user communication device to input prescription drug data to be returned, a host communication device to receive the prescription drug data and a wireless device to transmit the drug data to the host communication device.

A method for the return of prescription drugs may include the steps of inputting prescription drug data to be returned to a user communication device, receiving the prescription drug data by a host communication device and transmitting the drug data to the host communication device over a server.

The user may receive a preaddressed envelope in response to sending the drug return request.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a system view of the present invention;

FIG. 2 illustrates a communication device of the present invention;

FIG. 3 illustrates a screen shot of the home page of the present invention;

FIG. 4 illustrates a screen shot of the about PRx page of the present invention;

FIG. 5 illustrates a screenshot of the Our Service page of the present invention;

FIG. 6 illustrates a screenshot of the Why Return your Prescription Drugs of the present invention;

FIG. 7 illustrates a screenshot of the Why Return page of the present invention;

FIG. 8 illustrates a screenshot of the Contact Us page of the present invention;

FIG. 9 illustrates a screenshot of the Let's Get Started page of the present invention;

FIG. 10 illustrates a flowchart of the present invention;

FIGS. 11-24 illustrates a screenshot of the reports function of the present invention;

FIG. 25 illustrates a screenshot of the let's get started function of the present invention.

### DETAILED DESCRIPTION

The present invention may work with FDA leadership in providing Americans and others (the teachings of the present invention are equally applicable to other countries around the world) access to methods to achieving the goal of the safe return and recycle of prescription drugs, starting with facilitation of recycling of prescription medicine, consumer prescription medicine returns and plastic recycling.

The present invention may use the website which may be referred to as PRESCRIPTION RETURNS to provide a web-based platform for consumers to make their medicine returns: The present invention may:
Offer the consumer a platform to return prescription, over the counter medicine and other drugs for drug related paraphernalia, with FDA approval
Establish a gateway for the global pharmaceutical industry to implement a return policy
Offer local communities a medicine return program for improving the quality of local water resources, facilitating better health for their communities Become the first country to offer citizen medicine return programs. The present invention will facilitate clean waterways, cleaner landfills, and a reduction in plastic
Establish clean waterways, because every American citizen deserves clean and healthy water
With FDA approval, bring innovative, collaborative, transparent and accountable measures involving pharmacies, hospitals, pharmaceutical industry, local communities and the American consumer.
Recycle unused medicine, and lower raw medical manufacturing material cost
Reduce plastic waste in local community landfills

The website such as PRESCRIPTION RETURNS may serve as a platform for consumers to enter their personal information viz., their address, name of the drug they want to return the quantity of drugs and the pharmaceutical industry. Additionally, the user may wish to describe the age of the drugs, and whether or not the drugs have been opened. The user immediately may receive a pre-paid mailing package and instructions on returning the prescriptions. The mailing package may identify the enclosed prescriptions, and the host to the website may store the personal information and the pharmaceutical information in order to crossmatch the information when the mailing package is returned to the warehouse of the host to the website

The host to the website may be a warehouse which may be owned by the MEDICINE RECYCLE CORPORATION which may work with all major pharmaceutical companies to offer a prescription-return or drop-off program using this website. The company may use DEA approved United Parcel Service and US Postal Service for pick up, warehousing logistics and processing of medical returns for each company.

While the returned plastic bottles may be recycled, unused medicines will be sorted and stored in security warehouses, based on a vendor-relationship with the respective pharmaceutical companies.

Subject to approval from FDA, these unused medicines can be redistributed to other countries or to needy residents. Used and out-of-date medicines may be destroyed by incinerated or subject to appropriate waste management techniques.

### Benefits

The immediate benefits of the present invention that can percolate down to consumers, corporations and the environment are:
Clean water in local communities because studies show that municipal wastewater treatment may not always completely or successfully remove medications or byproducts. The present invention facilitates this by the safe return of pharmaceuticals instead of flushing them down the commodes or being placed into trash cans and.
Reduce plastic waste in local community landfills
Recycle plastic material used in non-hazardous medicines
Repackage unused medicine, after approval from FDA. If this is permitted, then medicine can will be available either free or at reduced rates to the under-privileged

### Methodology

The present invention includes PRESCRIPTION RETURNS website which may be a gateway for the pharmaceutical industry, the consumer and the local communities to log on and dispose medicine returns.

By making the return process simple for the consumer and profitable for the pharmaceutical industry, the present invention which may include MEDICINE RECYCLE CORPORATION may be able to provide environmentally conscious disposal of the non-returnable medicine waste—being in compliance with the State and Federal EPA regulations.

### Qualifications

The present invention which may include the website which may be known as PRESCRIPTION RETURNS may facilitate the process of returning unused medicine, provide an improved process for consumers and also enable pharmaceutical industry players to bring in a more disciplined, yet feasible approach to medicine returns.

The present invention which may include MEDICINE RECYCLE CORPORATION may use the website such as PRESCRIPTION RETURNS to:
Offer the user a platform to return prescription and over the counter medicine, with FDA approval
Establish a gateway for the global pharmaceutical industry to implement a return policy for prescription drugs
Offer local communities a medicine return program for improving the quality of local water resources, facilitating better health for their communities

The present invention may include the MEDICINE RECYCLE CORPORATION which may cooperate with all or most major pharmaceutical companies to offer a prescription-return or drop-off program using the website. The present invention may use DEA approved United Parcel Service and US Postal Service for pick up, warehousing logistics and processing of medical returns for each company.

The present invention which may include the MEDICINE RECYCLE CORPORATION and the process-driven website which may be the PRESCRIPTION RETURNS may facilitate a wider acceptance by the pharmaceutical industry players and immediate implementation by consumers, making the process of returning unused medicine feasible and easy.

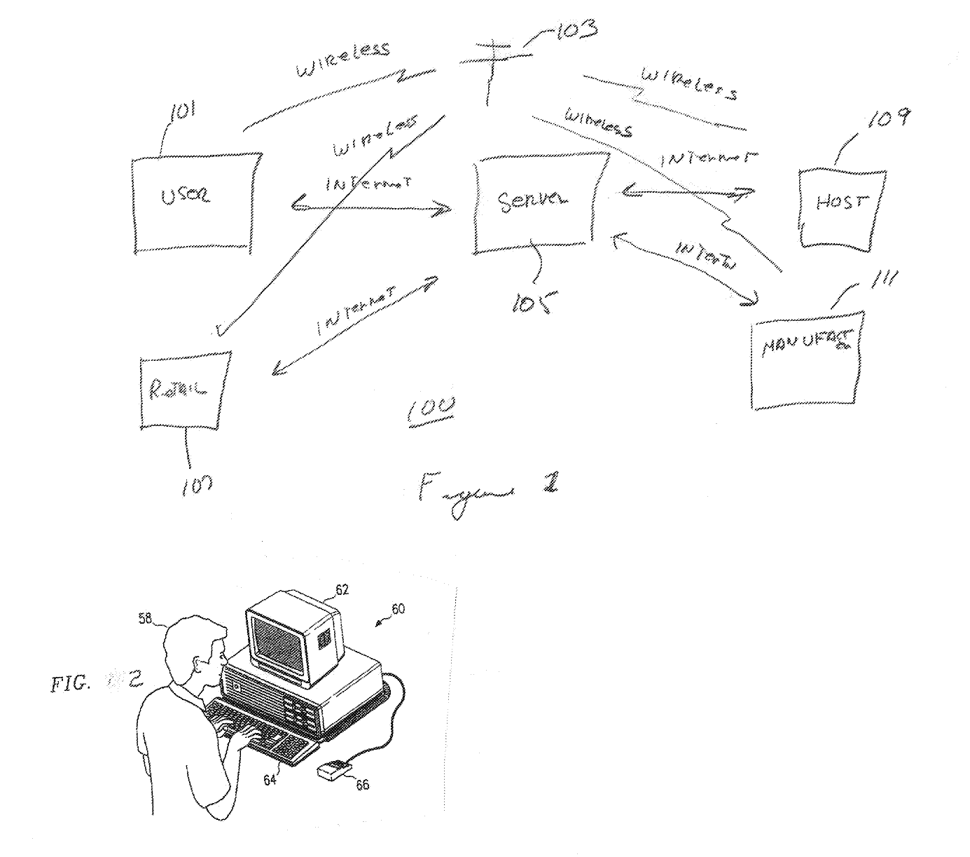

FIG. 1 illustrates a system diagram of the drug return system 100 of the present invention, and the drug return system 100 may include a user communication device 101 which may allow the user of the drug return system 100 to return used or discarded drugs by inputting drug data which describes the drugs that are going to be returned, a retail communication device 107 which may allow a retail establishment such as a drugstore or a retail store which may sell drugs to return unsold or return drugs to the drug return system 100 by inputting drug data which describes the drugs to be returned, a manufacturer communication device 111 which may allow a manufacturer of drugs to receive the drugs from the user or the retail store by receiving the drug data which describes the drugs to be returned, and a host communication device 109 to receive and transmit drug return data 113 from either the user communication device 101, the retail communication device 107 or the manufacturer communication device 111. The user communication device 101, the retail communication device 107, the manufacturer communication device 111 or the host communication device 109 may be a communication device such as a computer, PDA, cell phone, blackberry, tablet or other comparable device. These devices 101, 107, 109, 111 maybe capable of wireless communication through a wireless terminal 103 which may be a wireless antenna, a cell phone tower or other appropriate device or maybe capable of a wired connection through the Internet by a server 105. The wireless terminal 103 or the server 105 may be capable of detecting a destination address from the user communication device 101, the retail communication device 107, the host communication device 109 and the manufacture communication device 111 and subsequently directing the data having the destination address to the communication device 101, 107, 109, 111 in accordance with the destination address. The present invention may refer to prescription drugs which may include drugs prescribed by a physician, over-the-counter medicines/drugs, sample medicines/drugs or other types of medicines/drugs.

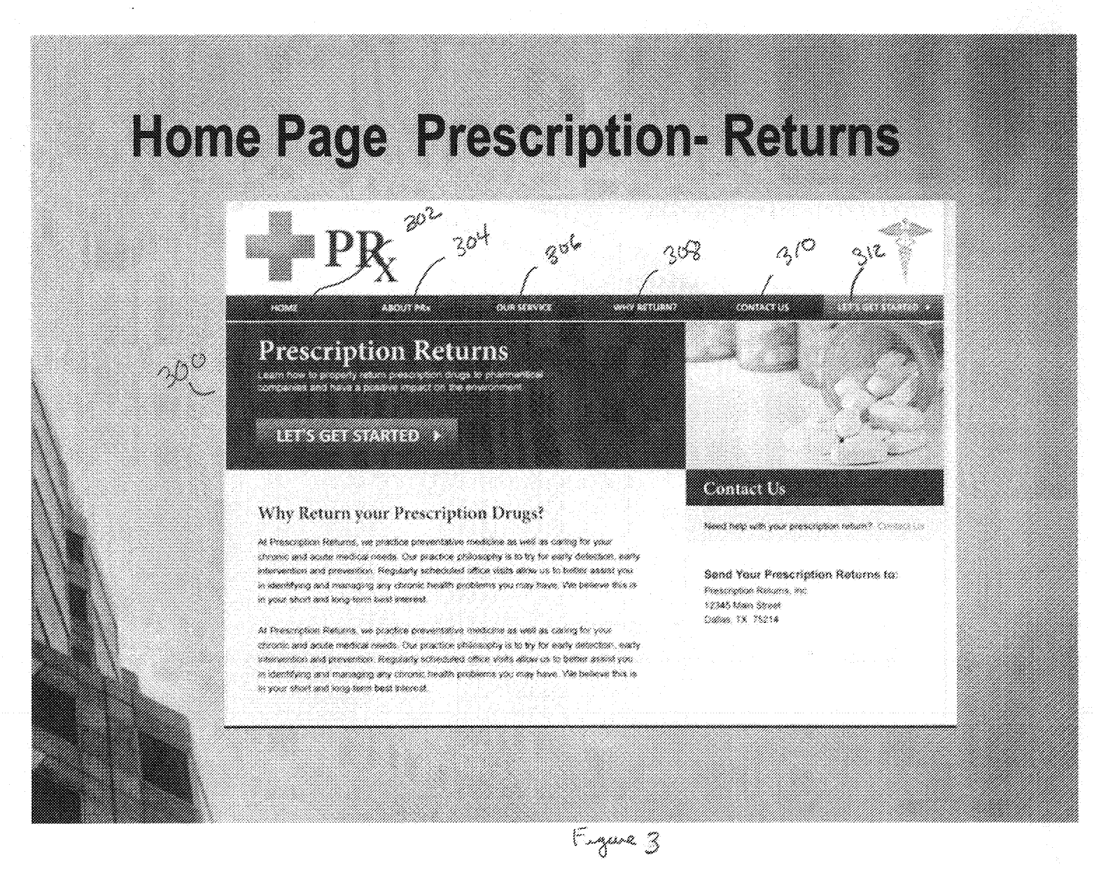

FIG. 2 illustrates a communication device which may be a personal computer 60 and may be used as the user communication device 101, the retail communication device 107, the manufactured communication device 111 or the host communication device 109. The personal computer may include a keyboard 64 to allow the user 58 to input data into the personal computer 60, a mouse device 66 to input data and to control the personal computer 60 and a monitor 62 to display information from the personal computer.

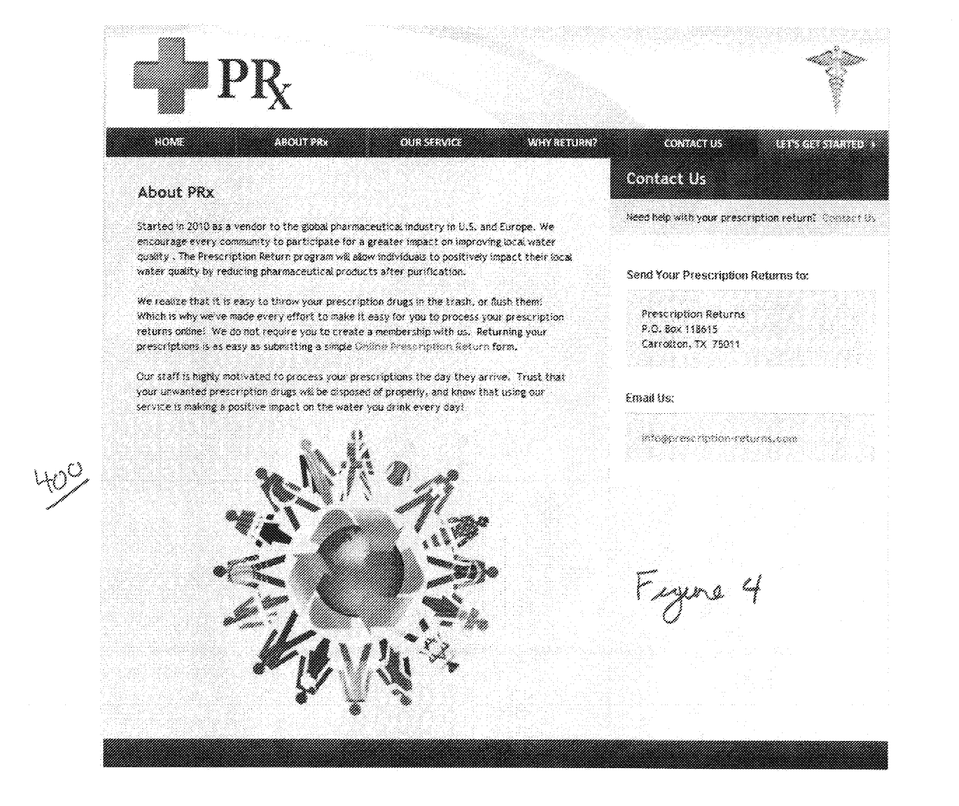

FIG. 3 illustrates a homepage display 300 which may be displayed on the monitor 62. The homepage display 300 may include a home button 302 to bring up the homepage display 300, an about PRx button 304 to activate the about PRx page, an our service button 306 to bring up the our service page, a why return button 308 to bring up the why return page, a contact us button 310 to bring up a contact us page and a let's get started button 312 to help the user return prescriptions.

The homepage 300 provides reasons why to return prescriptions which may include the practice of preventive medicine as well as for caring for chronic and acute medical needs. The home page encourage early detection, early intervention and prevention and encourages regularly scheduled office visits to allow for better assistance in identifying and managing any chronic health problems. The homepage 300 encourages the short and long-term best interest of the patient.

FIG. 4 illustrates a screen shot of the About PRx page of the present invention and illustrates that the present invention acts as a vendor to the global pharmaceutical industry in the United States, Europe and the rest of the world. The present invention encourages that every community participate for improving local water quality. The prescription return program of the present invention may allow individuals to positively impact the local water quality by reducing pharmaceutical pollution. While the present invention recognizes that it is easy to discard prescription drugs in the trash or to flush the pharmaceuticals, the present invention does not require that a membership be created. Returning prescriptions is as easy as filling out and submitting information on the return form.

The staff of prescription returns will process your return prescriptions the day that they arrive. The users will be assured that their unwanted prescription drugs will be disposed of properly, making a positive impact on the water that you drink every day.

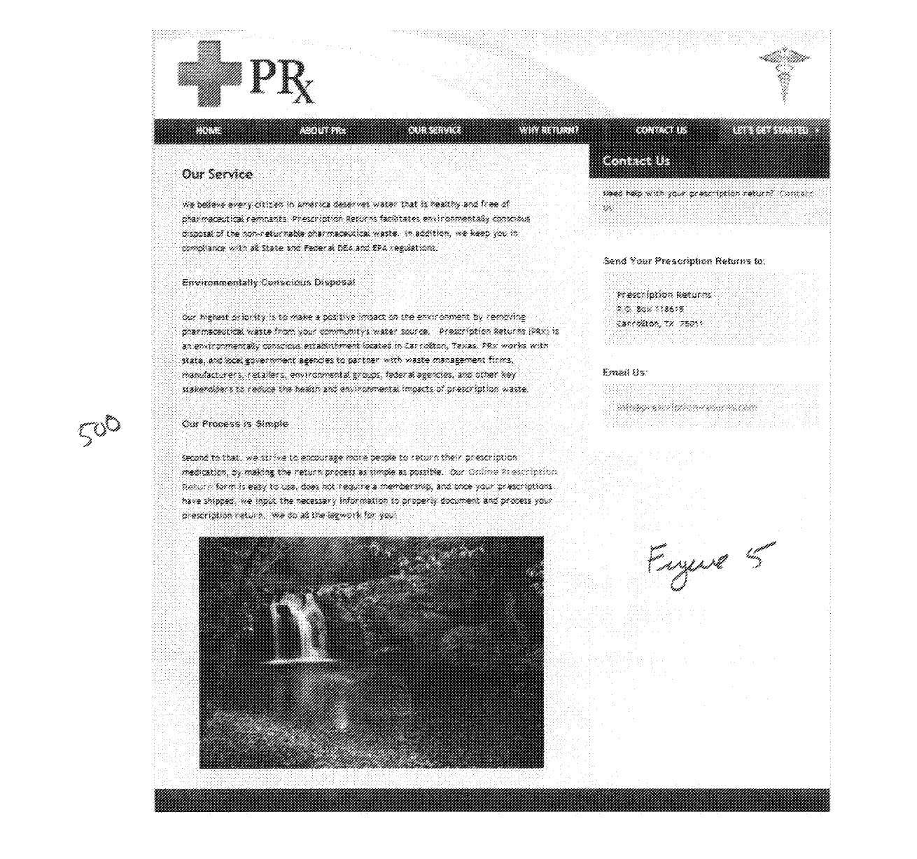

FIG. 5 illustrates screen shot of Our Service page 500 of the present invention.

The present invention believes that every citizen in America deserves water that is healthy and substantially free of pharmaceutical remnants. The prescription returns of the present invention facilitates environmentally friendly disposal. In addition, the present invention will maintain compliance with substantially all State and Federal DEA and EPA regulations. The process of returning pharmaceuticals is substantially simple to encourage more people to return their prescription medication and other medications. The present invention employs a return form which is easy to use and does not require a membership. Once that the prescription drugs have been shipped and arrived, the present invention includes the necessary information to process the prescription returns.

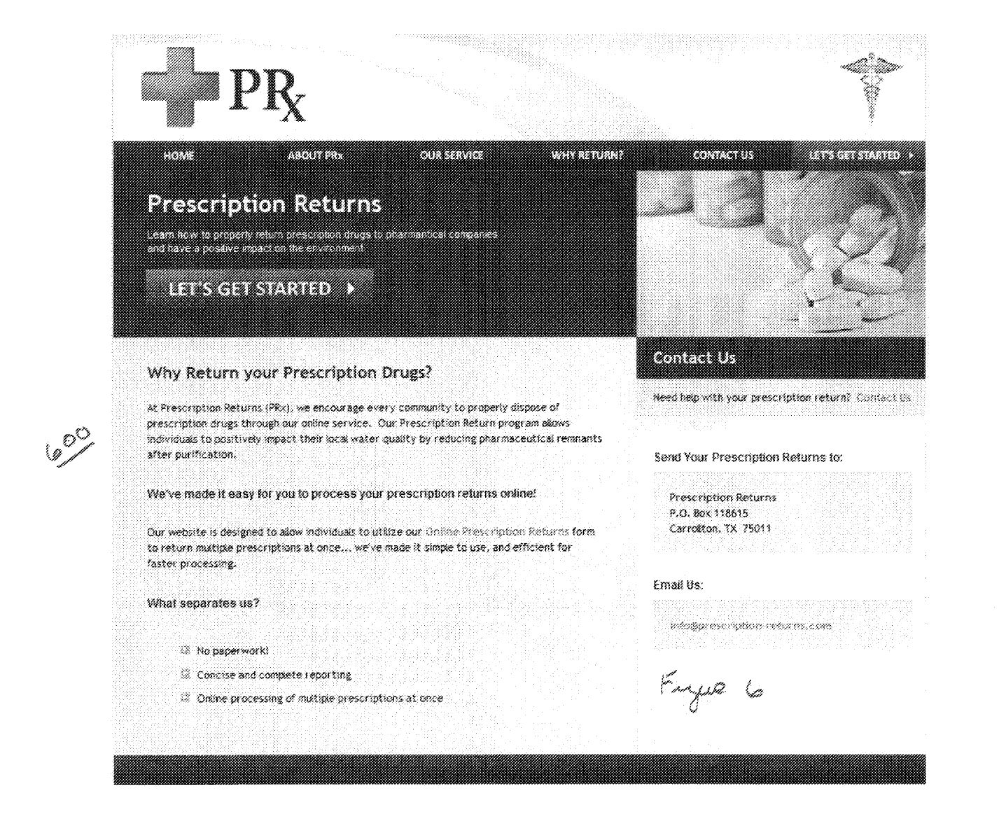

FIG. 6 illustrates a screenshot 600 of the Why Return your Prescription Drugs page, and the screenshot 600 illustrates that the present invention encourages every community to properly dispose of prescription drugs through the online service of the present invention. The disposal of prescription drugs with the present invention allows individuals to positively impact the local water quality by reducing and substantially eliminating pharmaceutical remnants which may exist after the water has been purified will find the local water authority. The present invention may allow for multiple and different prescriptions to be returned without the need to identify each prescription with the user. The present invention eliminates the need for paperwork and provides concise and complete reporting of the prescription drugs to be returned.

FIG. 7 illustrates a screenshot of a Why Return page 700 and illustrates that the present invention provides advantages to the return/pharmacy drop-off program which may include an improvement in local community water quality and provide healthy water which provides healthy people. Additionally, the present invention provides advantages of recycling and renewing which may lower raw medical manufacturing material cost and may reduce plastic waste in local community landfills.

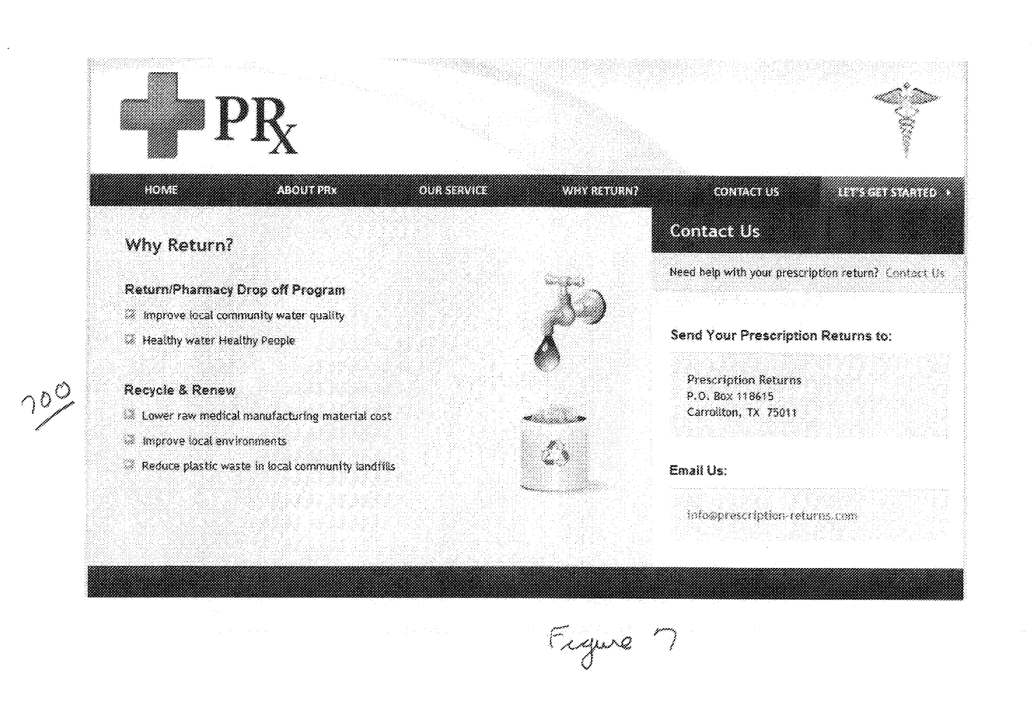

FIG. 8 illustrates a screenshot of the contact us page 800 which provides the opportunity for the user to submit name, address, phone number, e-mail and a question. The page 800 advises the user that he/her has the opportunity to know more about Prescription Returns.

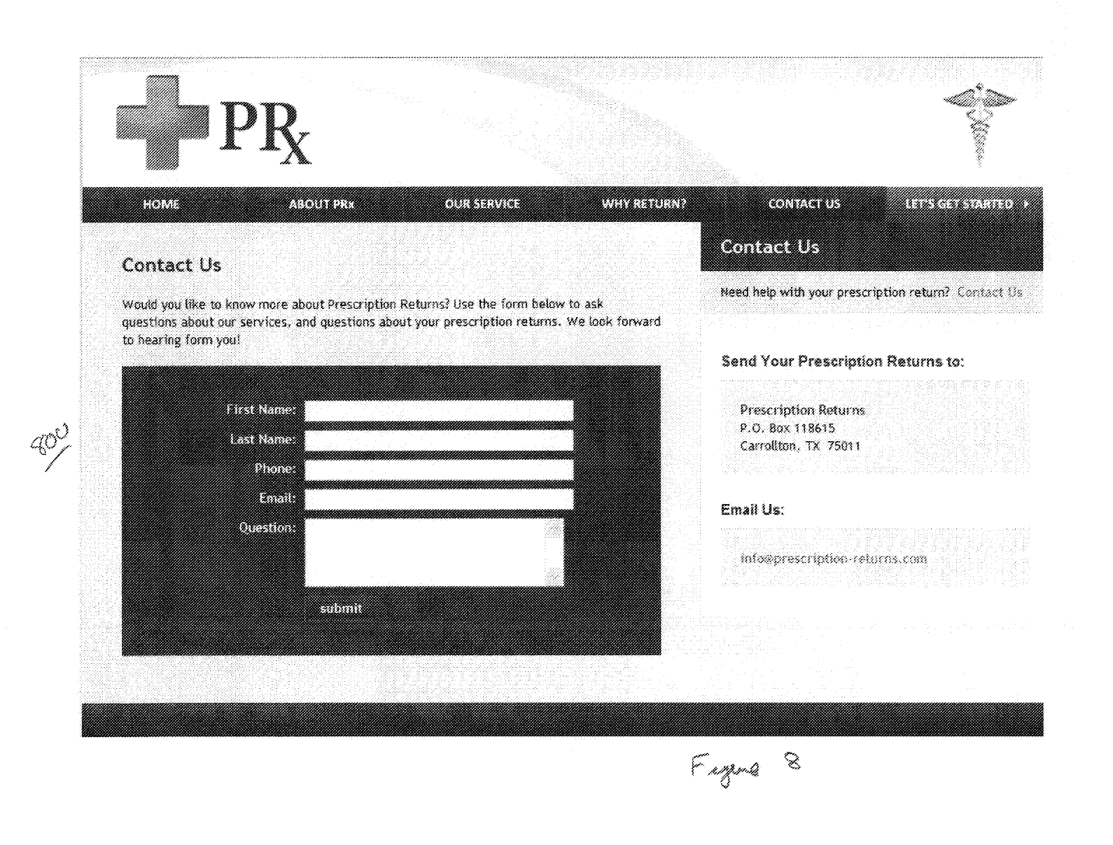

FIG. 9 illustrates a screenshot of a Let's Get Started page 900 and provides the user with the opportunity to provide an indication of the number of prescriptions that are being returned.

FIG. 10 illustrates a flowchart of the present invention and illustrates in step 1001, that the user initiates a drug return requests through the user communication device 101. In step 1003, the host communication device 109 receives the drug return request, and in step 1005 the host sends out a physical envelope to the user to obtain the drug. In step 1007, the user places the drugs in an envelope to return the drugs.

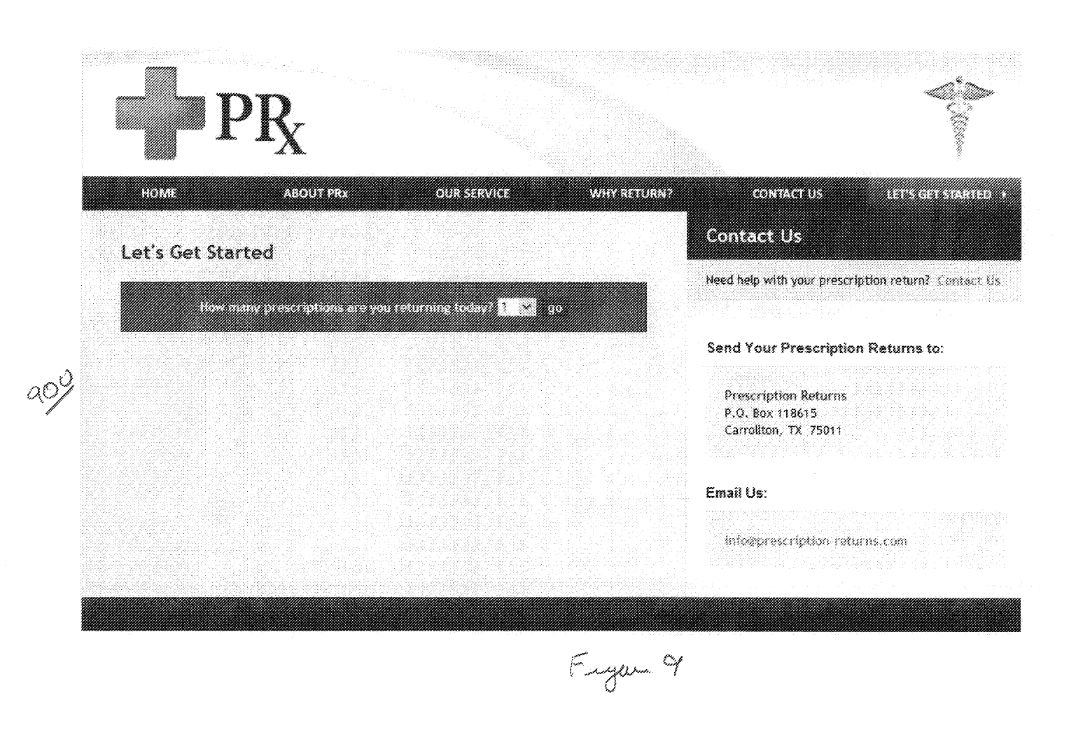

FIGS. 11-24 may illustrate the various ways that reports may be generated. These figures show that every report may be generated based upon common information and then displayed.

FIG. 11 illustrates that the common information may be by prescription, and the report may list the name of the drug manufacture, the name of the country and the generic names of the drug (if any).

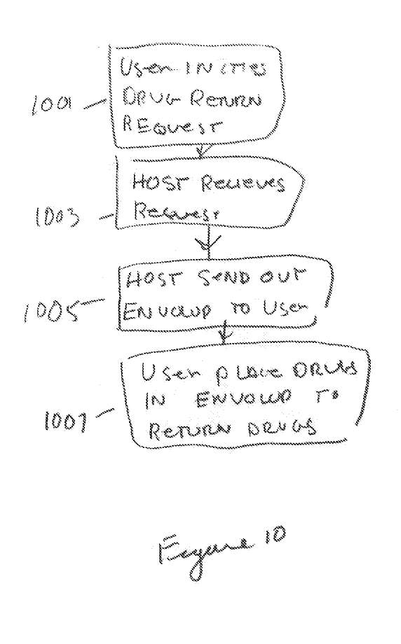

FIG. 12 illustrates that the common information may be by pharmacy, and the report may list the company name, the address of the pharmacy, the telephone number of the pharmacy and the pharmacist name.

FIG. 13 illustrates that the common information may be by drug manufacture and may list the name of the drug manufacture and the date.

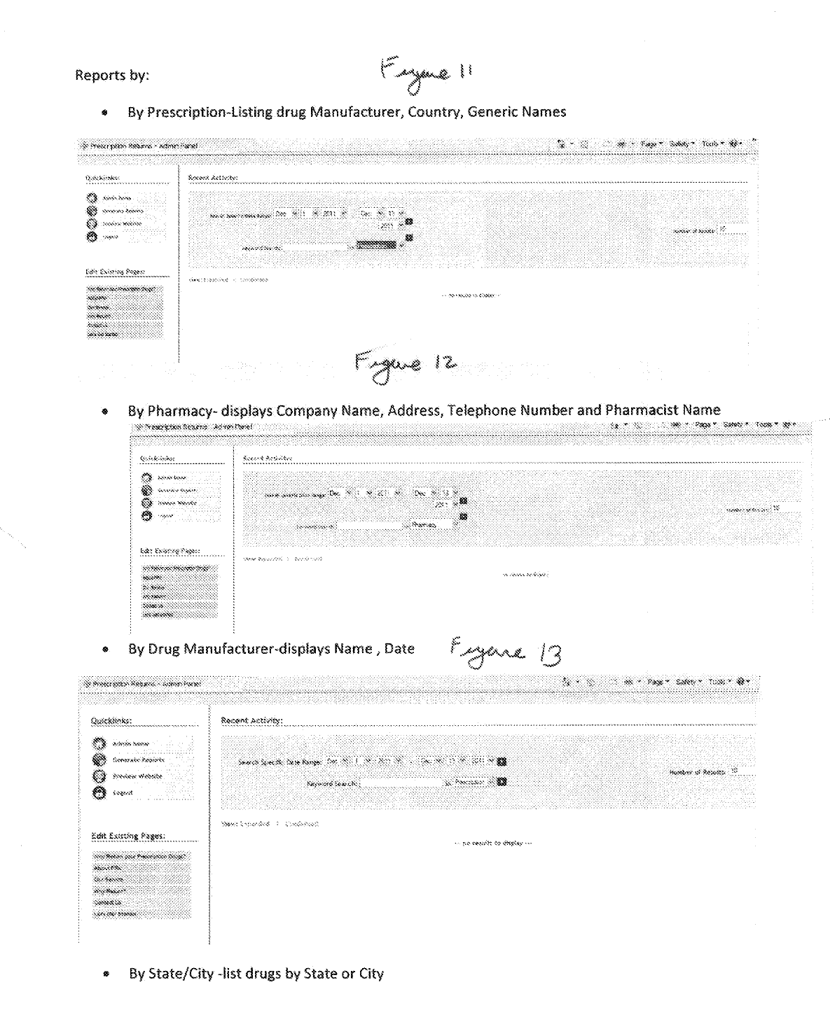

FIG. 14 illustrates that the common information may be by city and may list the drugs by the city.

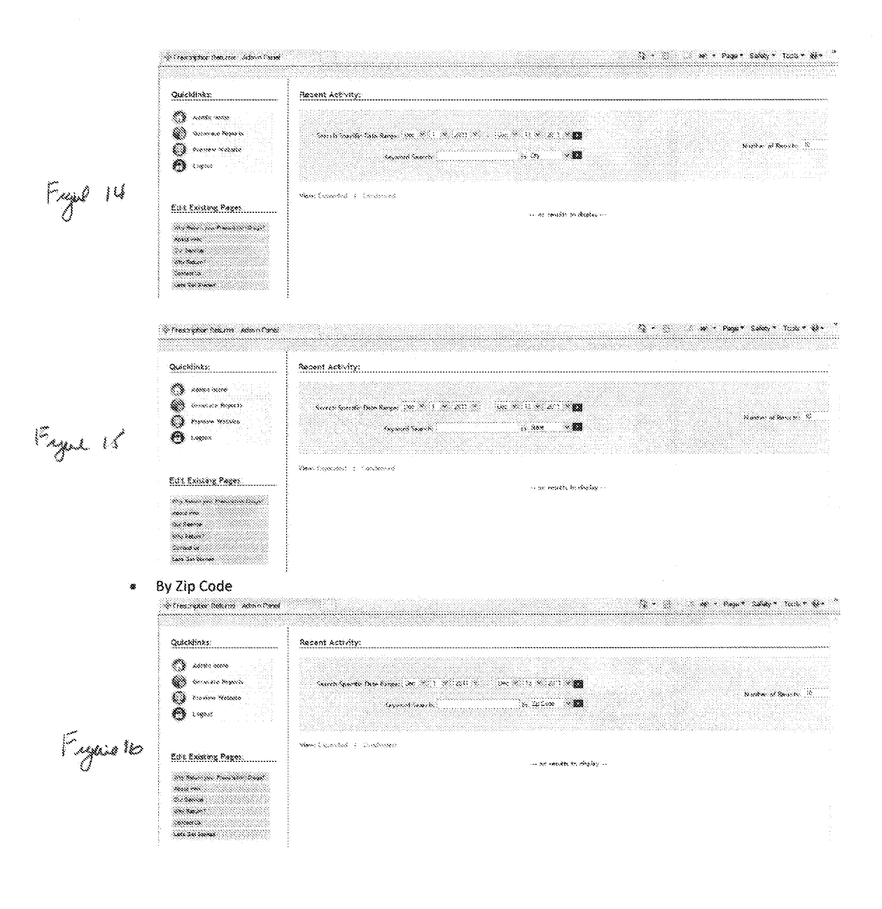

FIG. 15 illustrates that the common information may be by state and may list the drugs by the state.

FIG. 16 illustrates the common information may be by zip code and may list the drugs by the zip code.

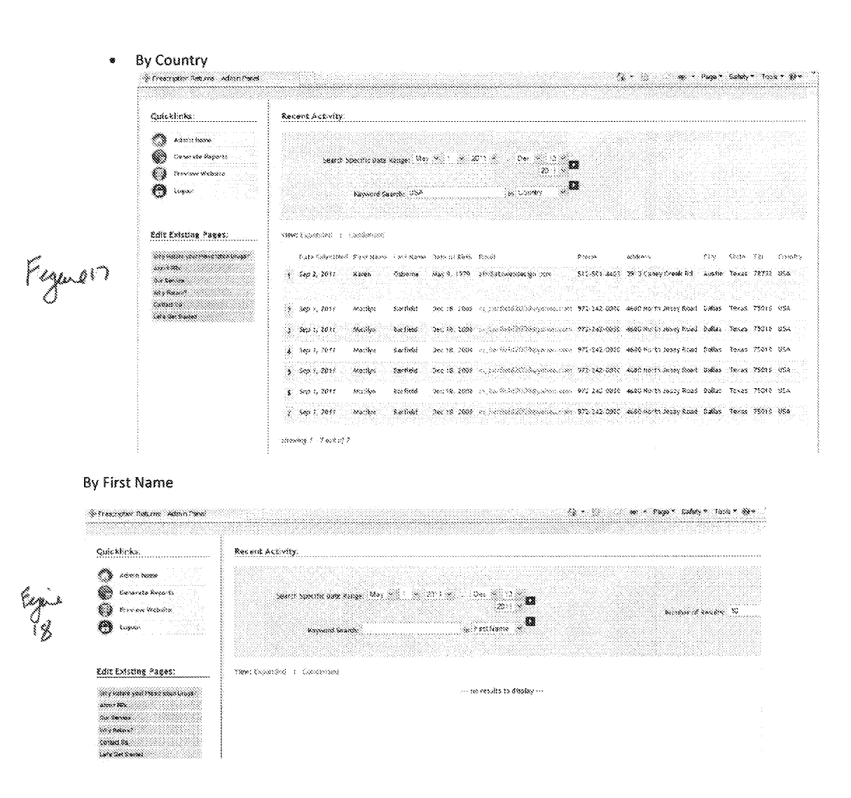

FIG. 17 illustrates the common information may be by country and may list the drugs by the country.

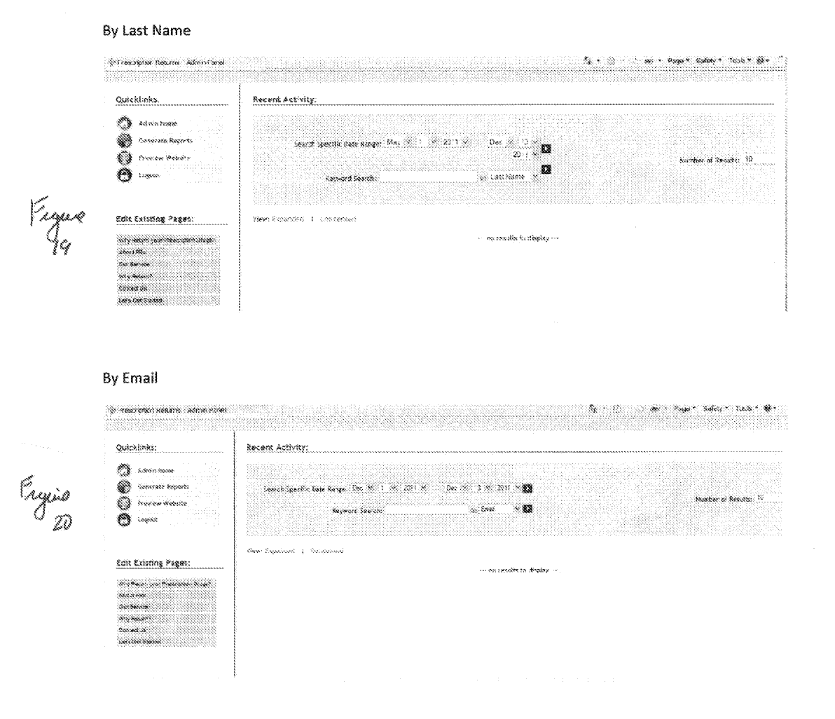

FIG. 18 illustrates the common information may be by first name of the user and may list the drugs by the first name.

FIG. 19 illustrates that the common information may be by last name of the user and may list the drugs by the last name.

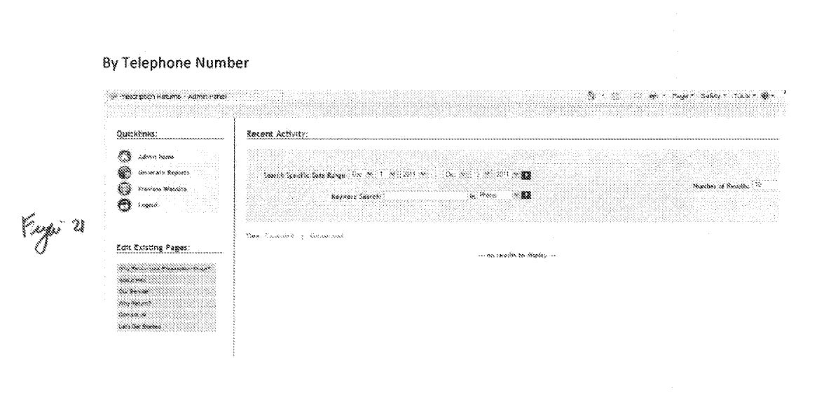

FIG. 20 illustrates that the common information may be by e-mail address and may list the drugs by the e-mail address.

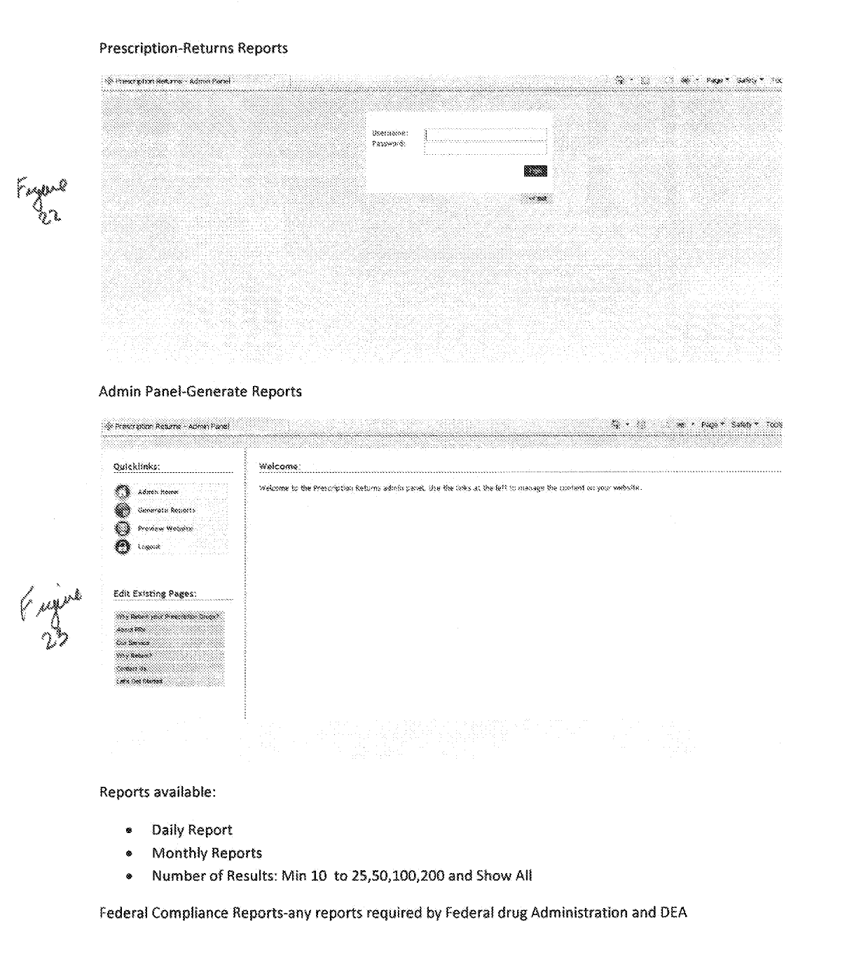

FIG. 21 illustrates that the common information may be by telephone number of the user and may list the drugs by the telephone number.

FIG. 22 illustrates the prescription returns report screenshot which may include the username and password.

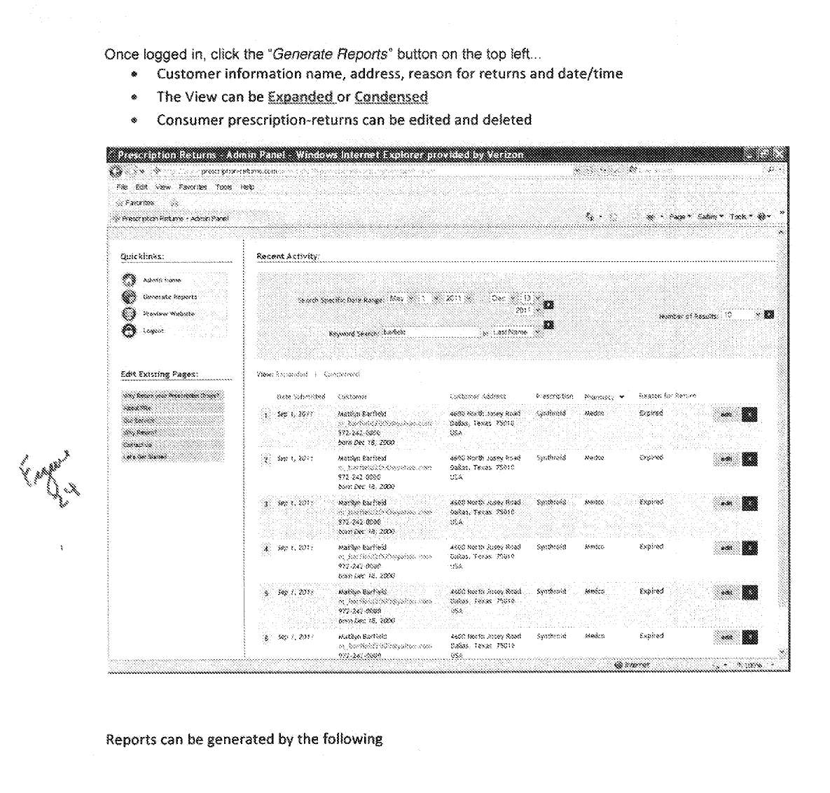

FIG. 23 illustrates the generate reports screenshot which may facilitate daily reports and monthly reports and may list the number of results by varying amounts.

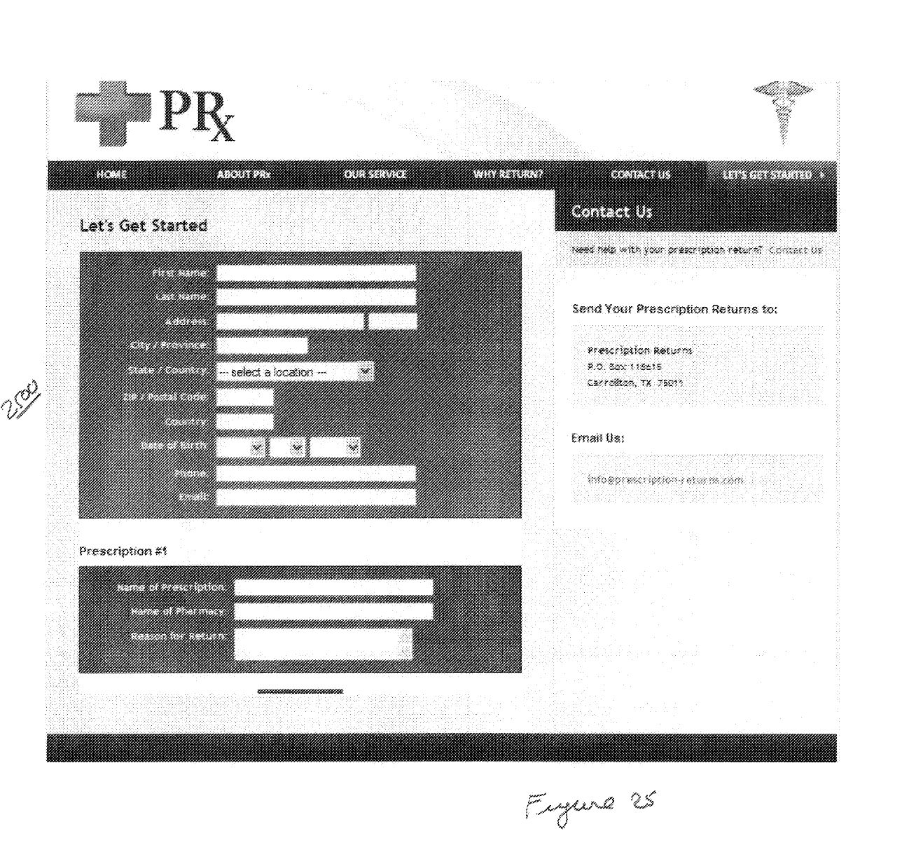

FIG. 24 illustrates a sample reports which may show the user information including name, address, reason for returns of the drugs and date/time.

FIG. 25 illustrates a screenshot 2500 of the let's get started function of the present invention and illustrates that the users name and address can be inputted as well as the name of the prescription, the name of the pharmacy and the reason for the return.

The number of entries can be expanded or condensed and the returns can be edited and deleted.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An apparatus for the return of prescription drugs, comprising:
a user communication device to input prescription drug data to be returned;
a host communication device to receive the prescription drug data;
a server to transmit the drug data to the host communication device.

2) An apparatus for the return of prescription drugs, comprising:
a user communication device to input prescription drug data to be returned;
a host communication device to receive the prescription drug data;
a wireless device to transmit the drug data to the host communication device.

3) A method for the return of prescription drugs, comprising the steps of:
inputting prescription drug data to be returned to a user communication device;
receiving the prescription drug data by a host communication device;
transmitting the drug data to the host communication device over a server.

4) An apparatus for the return of prescription drugs as in claim 1, wherein the user receives a preaddressed envelope in response to sending the drug return request.

5) An apparatus for the return of prescription drugs as in claim 2, wherein the user receives a preaddressed envelope in response to sending the drug return request.

6) A method for the return of prescription drugs as in claim 3, wherein the user receives a preaddressed envelope in response to sending the drug return request.
